(19) United States
(12) Patent Application Publication
(10) Pub. No.: US 2005/0226709 A1
(43) Pub. Date: Oct. 13, 2005

(54) Hay bale retriever and stacker

(76) Inventor: Arnel Koster, Tulare, CA (US)

Correspondence Address: National IP Rights Center, LLC, Suite 400, 550 Township Line Road, Blue Bell, PA, 19422, US

(21) Appl. No.: 10/801,080

(22) Filed: Mar. 15, 2004

(51) Int. Cl. B60P 1/00

(52) U.S. Cl. 414/501

(57) ABSTRACT

A hay bale retriever/stacker is disclosed. The hay bale retriever/stacker includes a static bed, having a front end and a rear end; a tilt bed, pivotally mounted at the rear end of the static bed; a hay engagement portion, mounted on the tilt bed, for engaging a hay bale during retrieval; a headache rack, slidably mounted on the static bed, capable of sliding from a first position proximate to the rear end of the static bed to a second position proximate to the front end of the static bed; a hay bale stabilizer disposed on the static bed proximate to the rear end of the static bed to stabilize the hay bale; a first hydraulic ram mounted on the tilt bed to move the hay bale forward to the static bed; a second hydraulic ram mounted on the tilt bed, proximate to the first hydraulic ram, to move the hay bale forward to the static bed; and a hydraulic winch and cable mounted on the static bed for slidably moving the headache rack from the second position to the first position.

### FIELD OF THE INVENTION

The present invention relates to agricultural equipment and in particular to a hay bale retriever and stacker.

### BACKGROUND OF THE INVENTION

In the South Western United States, the hay business is very large. In fact, the hay being made in the United States could well exceed five million tons per year, and every ton of this hay must be moved from field to farm, whether it be a dairy, feedlot or export operation. Oftentimes, the distances that the hay bales are to be transported can be quite far away. A typical hauled load of 25 tons will be repeated multiple times from the same location to service the farmer's needs. For this reason, it is important that efficient ways of transporting hay are employed.

U.S. Pat. No. 6,079,926 is directed to a self-propelled hay bale retriever and stacker for loading, transporting, and unloading bales of hay. The retriever/stacker has a tiltable bed for receiving the bales, and has movable side railings mounted to the bed, with each side railing carrying pivotal upper racks. The retriever/stacker also has a pair of spreadable forks mounted to the aft end of the bed. Attached to the front end of the retriever/stacker is a loader for lifting bales off the ground and moving them onto the bed.

U.S. Pat. No. 6,220,811 is directed to a vehicle bed, comprising a bed frame adapted for carrying a load, a fork including at least one tine, and a pivot mechanism adapted for pivoting the bed frame and the fork between a first position and a second position with respect to a vehicle frame. The fork is connected to an end of the bed frame and is substantially orthogonal to the bed frame. Loads are transported on the bed frame in the first position and are moved off or on the fork in the second position. The vehicle bed may be incorporated as part of a truck bed or as part of a trailer bed for a bale loading apparatus. The vehicle bed may include a lift mechanism including a lift cylinder adapted for lifting a load with respect to the vehicle frame to compensate for a load weight compressing a vehicle suspension. The bale loader includes a boom having a mast rotatably attached to a vehicle or trailer frame, a main boom pivotally attached to the mast, a jib boom pivotally attached to the main boom, and a head swivably attached to the jib boom. The boom is adapted for handling and stacking bales on the vehicle bed. The swivel head is preferably a two-in-one head adapted for handling dry bales and wet bales without puncturing plastic wrapped around the wet bales. The bale loader further includes at least one mobile outrigger operably attached to the vehicle frame and adapted for stabilizing the load. The mobile outrigger is telescopically extendible.

U.S. Pat. No. 5,542,803 is directed to a bale picker and stacker, including a control cab on a primary frame. The control cab and a steering controller are mounted to the primary frame for movement between a forward position at the frame front end and a rearward position outwardly along side the frame and adjacent the rearward frame end. A steering reverser is connected to the steering controller for reversing steering operation at the forward or rearward positions of the control cab. A lifting bed on the primary frame includes a top bale receiving surface moves between substantially horizontal and vertical positions. A bale pick-up on the lifting bed, includes a leg section and an outwardly projecting platform section. The bale pick-up moves between (a) a first position with the platform section adjacent the ground surface and parallel to the top bale receiving surface of the lifting bed, (b) a second position wherein the platform section is substantially perpendicular to the top bale receiving surface and disposed toward the rear end of the primary frame, and (c) a third position wherein the platform section is substantially perpendicular to the top bale receiving surface and disposed toward the front end of the primary frame from the second position. A bale squeezing frame is mounted to the lifting bed opposite to the bale pick-up and is movable toward the bale pick-up.

U.S. Pat. No. 6,478,522 discloses a bale handling apparatus which is mounted to a trailer and includes a frame, upper and lower bale cradles, cradle actuating hydraulic cylinders and upper and lower bale retaining means. Each bale cradle may be pivoted to eject bales. Each upper bale cradle is disposed directly above a lower bale cradle.

U.S. Pat. No. 4,619,570 is directed to a bale loading-stacking apparatus for mounting on the bed or frame of a truck, trailer or the like to collect and load bales, such as bales of hay, and to deposit the collected bales at an accumulation location. The apparatus includes an accumulator platform pivotally mounted to the bed or frame of the truck, trailer, or the like to permit the platform to be pivoted between a horizontal position for loading the bales to a vertical position for depositing a stack of bales. A bale loading apparatus is mounted at the rear of the platform which includes a loading ramp pivotally mounted so as to be pivotable between a generally horizontal position at ground level extending rearwardly of the platform and a generally vertical position extending above the rear end of the platform. Power means are provided for pivoting the platform and for pivoting the loading ramp. Preferably, at least two retriever arms are pivotally mounted on opposite sides of the platform, with the arms being pivotable inwardly to grip bales on the platform and outwardly to a non-gripping position.

U.S. Pat. No. 5,405,229 is directed to a novel self propelled “big bale” stacker and retriever capable of stacking 4 by 4 by 8 foot, 3 by 4 by 8 foot, or pairs of 2 by 3 by 8 foot bales in 8 by 8 foot stable, tied units is presented. The stacker of the present invention utilizes a novel “jaw”-like arm that clamps onto a bale lying in a field. The arm swings up vertically and deposits the bale on a rotatable horizontal platform. The rotatable platform rotates 180 degrees to make room for a second bale next to the first. After two bales have been loaded onto the rotating platform, the platform tilts up 90 degrees to deposit the bales on the stacker's bed. By rotating the platform 90 degrees before depositing the bales on the bed, the orientation of the bales in successive tiers can be alternated so as to produce stable, “tied”, 8 by 8 by 16 foot stacks.

U.S. Pat. No. 5,211,345 is directed to a system for handling bales of feed includes a freight trailer with a tongue that can be offset laterally to cause the trailer to follow a path to one side of the path of a tractor to permit a front-loading device on the trailer to engage bales of feed and raise them onto a load-carrying platform of the trailer. The platform is tiltable downward to the rear to induce sliding movement of loaded bales, and to release said bales in a vertical stack. The platform is provided with a device to grip the top bale of a stack and insert a lifting member under the stack to retrieve it for feeding operations. The platform is tiltable downward-forward to induce forward movement of the bales for release onto a bale shredder carried in part on the tongue of the trailer.

None of the above inventions, however, provide a cable drawn bale headache rack run system. There is therefore a need for such a system to reduce the cost of hay bale retrieving and stacking and to make it more efficient than what currently exists.

### OBJECTS AND SUMMARY OF THE INVENTION

It is an object of the present invention to provide a hay bale retriever and stacker.

It is a further object of the present invention to provide a hay bale retriever and stacker that can easily and efficiently retrieve and stack hay bales.

It is a further object of the present invention to provide a hay bale retriever and stacker that has a static bed, having a front end and a rear end; a tilt bed, pivotally mounted at the rear end of the static bed; a hay engagement portion, mounted on the tilt bed, for engaging a hay bale during retrieval; a headache rack, slidably mounted on the static bed, capable of sliding from a first position proximate to the rear end of the static bed to a second position proximate to the front end of the static bed; a hay bale stabilizer disposed on the static bed proximate to the rear end of the static bed to stabilize the hay bale; a first hydraulic ram mounted on the tilt bed to move the hay bale forward to the static bed; a second hydraulic ram mounted on the tilt bed, proximate to the first hydraulic ram, to move the hay bale forward to the static bed; and a hydraulic winch and cable mounted on the static bed for slidably moving the headache rack from the second position to the first position.

It is yet a further object of the present invention to provide a hay bale stacker/retriever that has a static bed, having a front end and a rear end; a tilt bed, pivotally mounted at the rear end of the static bed; a hay engagement portion, mounted on the tilt bed, for engaging a hay bale during retrieval; a headache rack, slidably mounted on the static bed, capable of sliding from a first position proximate to the rear end of the static bed to a second position proximate to the front end of the static bed; a hay bale stabilizer disposed on the static bed proximate to the rear end of the static bed to stabilize the hay bale; a first hydraulic ram mounted on the tilt bed to move the hay bale forward to the static bed; a second hydraulic ram mounted on the tilt bed, proximate to the first hydraulic ram, to move the hay bale forward to the static bed; a hydraulic ram mounted on the static bed, connected to the headache rack for sliding the headache rack from the second position to the first position; and a chain, the chain having one end mounted at an end of the hydraulic ram mounted on the static bed and the other end of the chain connected to the headache rack to slide the headache rack from the second position to the first position.

In accordance with a first aspect of the present invention, a novel hay bale stacker/retriever is provided. The hay bale retriever/stacker includes a static bed, having a front end and a rear end; a tilt bed, mounted at the rear end of the static bed; a hay engagement portion, mounted on the tilt bed, for engaging hay bale during retrieval; a headache rack, slidably mounted on the static bed, capable of sliding from a first position proximate to the rear end of the static bed to a second position proximate to the front end of the static bed; and a hay bale stabilizer disposed on the static bed proximate to the rear end of the static bed to stabilize the hay bale.

In accordance with another aspect of the present invention, a novel hay bale stacker/retriever is provided. The hay bale retriever/stacker includes a static bed, having a front end and a rear end; a tilt bed, pivotally mounted at the rear end of the static bed; a hay engagement portion, mounted on the tilt bed, for engaging a hay bale during retrieval; a headache rack, slidably mounted on the static bed, capable of sliding from a first position proximate to the rear end of the static bed to a second position proximate to the front end of the static bed; a hay bale stabilizer disposed on the static bed proximate to the rear end of the static bed to stabilize the hay bale; a first hydraulic ram mounted on the tilt bed to move the hay bale forward to the static bed; a second hydraulic ram mounted on the tilt bed, proximate to the first hydraulic ram, to move the hay bale forward to the static bed; and a hydraulic winch and cable mounted on the static bed for slidably moving the headache rack from the second position to the first position.

In accordance with yet another aspect of the present invention, a novel hay bale retriever/stacker is provided. The novel hay bale retriever/stacker includes a static bed, having a front end and a rear end; a tilt bed, pivotally mounted at the rear end of the static bed; a hay engagement portion, mounted on the tilt bed, for engaging a hay bale during retrieval; a headache rack, slidably mounted on the static bed, capable of sliding from a first position proximate to the rear end of the static bed to a second position proximate to the front end of the static bed; a hay bale stabilizer disposed on the static bed proximate to the rear end of the static bed to stabilize the hay bale; a first hydraulic ram mounted on the tilt bed to move the hay bale forward to the static bed; a second hydraulic ram mounted on the tilt bed, proximate to the first hydraulic ram, to move the hay bale forward to the static bed; a hydraulic ram mounted on the static bed, connected to the headache rack for sliding the headache rack from the second position to the first position; and a chain, the chain having one end mounted at an end of the hydraulic ram mounted on the static bed and the other end of the chain connected to the headache rack to slide the headache rack from the second position to the first position.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a side elevation view of a hay bale retriever/stacker in accordance with the present invention shown engaging bales of hay.

FIG. 2A is a top plan view of the hay bale retriever/stacker of FIG. 1, with a tilt bed shown in a horizontal position.

FIG. 2B is a top plan view of the hay bale retriever/stacker of FIG. 1, with the tilt bed shown in a vertical position.

FIG. 3A is a top plan view of a static bed of the hay bale retriever/stacker of FIG. 1.

FIG. 3B is a side cross section elevation of the static bed of FIG. 3A.

FIG. 4 is a side elevation view of the hay bale retriever/stacker of the present invention during a loading/unloading operation.

FIG. 5 is an end elevation view, in partial cross section of a hay bale stabilizer in accordance with the present invention of FIG. 2A along the lines 5-5.

### DETAILED DESCRIPTION OF THE PREFERRED EMBODIMENT

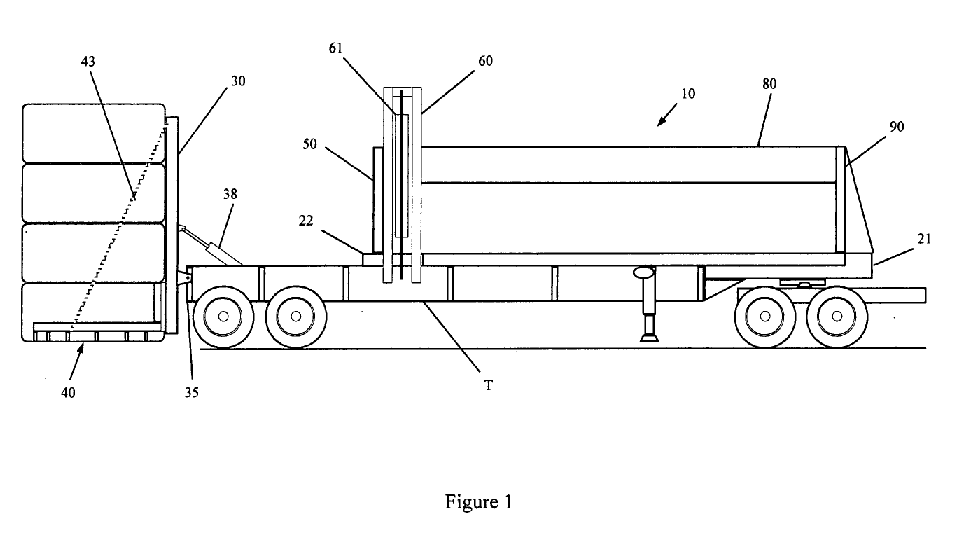

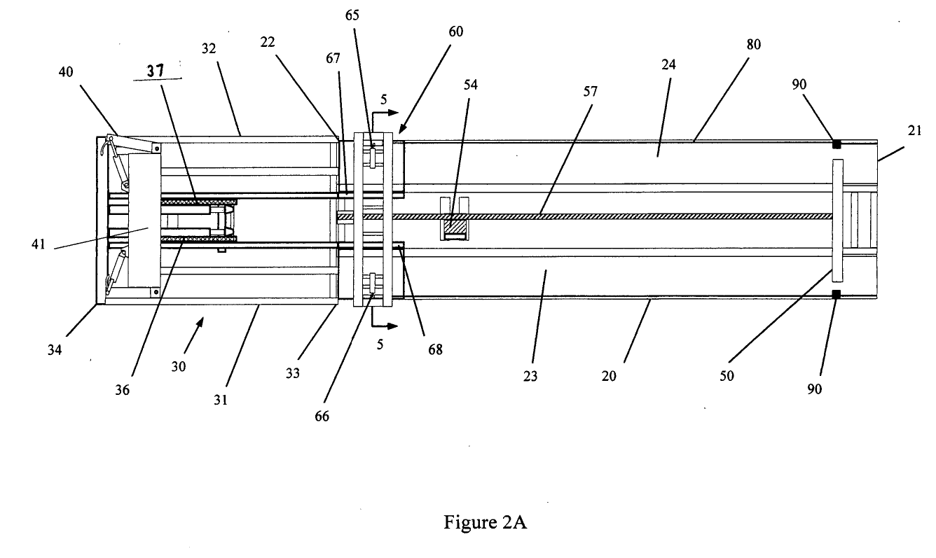

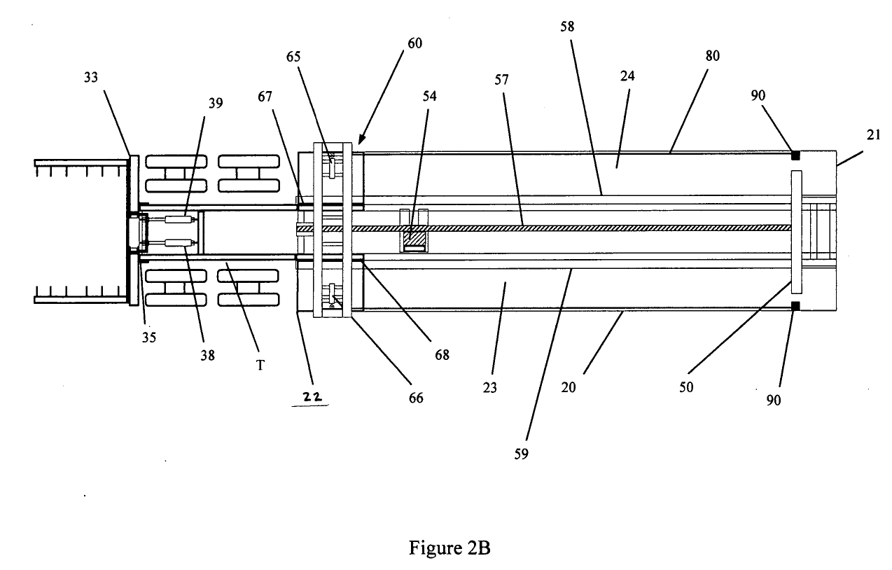

Referring now to the drawings, wherein like reference numerals refer to the same components across the several views and in particular to FIGS. 1, 2A and 2B, there is shown a hay bale retriever/stacker 10. The hay bale retriever/stacker 10 includes a static bed 20, and a tilt bed 30. Both the static bed 20 and the tilt bed 30 are attached to a trailer T.

The static bed 20 includes a front end 21 and a back end 22. The static bed 20 is comprised of a first generally rectangular section 23 and a second generally rectangular section 24. The first generally rectangular section 23 of the static bed 20 and the second generally rectangular section 24 of the static bed 20 are generally parallel to one another. A pair of corner posts 90 are mounted at the front end 21 of the static bed 20, and proceed generally perpendicularly upward therefrom. One corner post 90 is mounted on the outside corner of the first generally rectangular section 23 of the static bed 20 and the second corner post 90 is mounted on the outside corner of the second generally rectangular section 24 of the static bed 20. Mounted at the back end 22 of the static bed 20 is a hay bale stabilizer 60. The hay bale stabilizer 60 proceeds generally perpendicularly upward from the static bed 20 and is generally ‘U’ shaped so as to allow bales of hay to pass through the hay bale stabilizer 60. Static cables 80 are mounted on opposite sides of the static bed 20. One end of the static cables 80 are attached to the hay bale stabilizer 60 and the opposite end of the static cables 80 are attached to the corner posts 90.

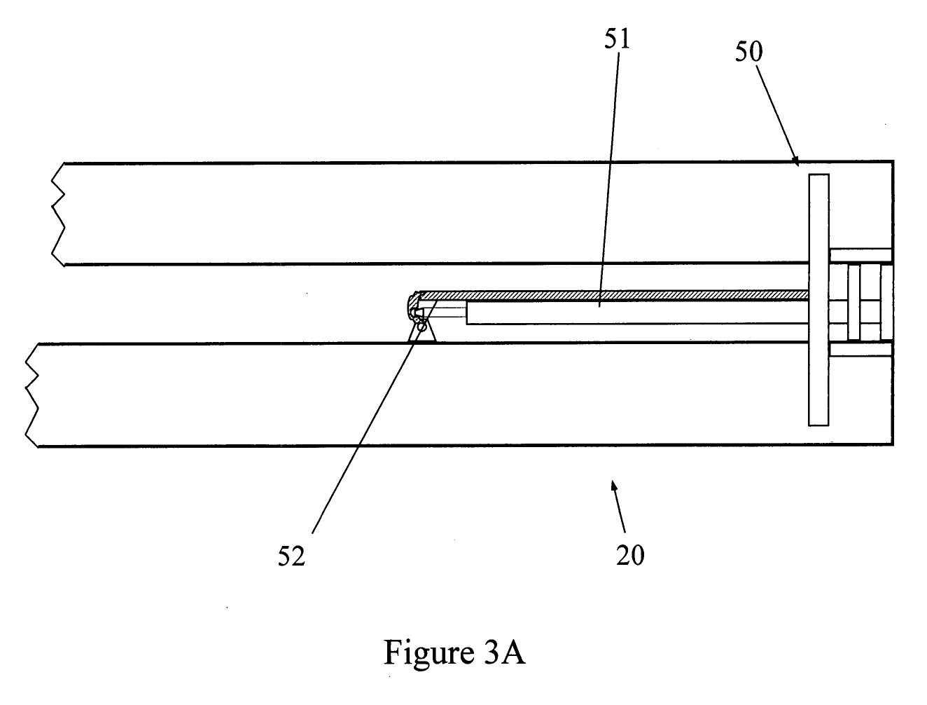

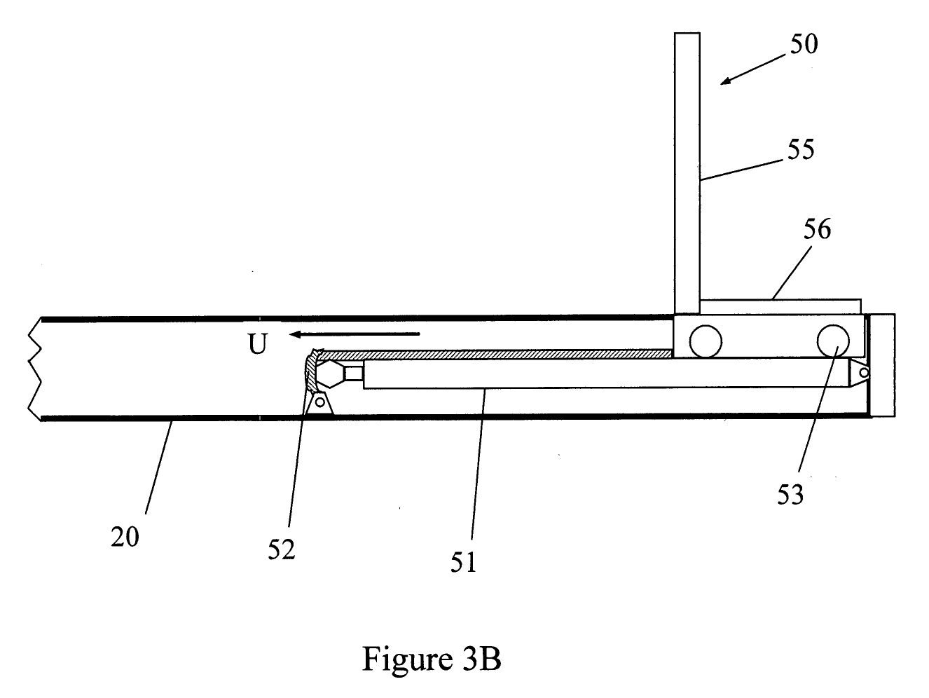

Mounted on the static bed 20 is a headache rack 50. The headache rack 50 includes a vertical portion 55 and a horizontal portion 56. The headache rack 50 is slidably mounted upon the static bed 20 such that the headache rack 50 moves from a first position, proximate to the back end 22 of the static bed 20 to a second position, proximate to the front end 21 of the static bed 20. Referring now to FIGS. 3A and 3B, the headache rack 50 and an accompanying system can be seen in more detail. A hydraulic ram 51 is disposed generally axially within the static bed 20 between the first generally rectangular section 23 and the second generally rectangular section 24 of the static bed 20. One end of the hydraulic ram 51 is mounted at the front end 21 of the static bed 20, and a first end of a chain 52 is located at a second end of the hydraulic ram 51. A second end of the chain 52 is attached to the horizontal portion 56 of the headache rack 50. A set of rollers 53 are likewise mounted on the horizontal portion 56 of the headache rack 50 in order to allow the headache rack 50 to slide from the first position to the second position.

Referring now to FIGS. 2A and 2B, an alternative system for the headache rack 50 is shown. A winch 54 is mounted on the static bed 20 proximate to the back end 22 of the static bed 20. Mounted to the winch 54 is one end of a cable 57. The opposite end of the cable 57 is mounted to the headache rack 50.

The tilt bed 30 is pivotally mounted on the trailer T and includes a first end 33 and a second end 34. The tilt bed 30 includes a first generally rectangular section 31 and a second generally rectangular section 32. A hay engagement portion 40 is slidably disposed at the second end 34 of the tilt bed 30 and proceeds generally perpendicularly outward therefrom. The hay engagement portion 40 is capable of sliding from a first position for engaging a bale of hay on the ground, to a second position, towards the first end 33 of the tilt bed 30. The hay engagement portion 40 includes a dolly 41 which slidably moves along with the hay engagement portion 40 from the tilt bed 30 onto the static bed 20. The tilt bed 30 is mounted to the trailer T at a pivot 35. The pivot 35 allows the tilt bed to rotate about an axis to pivot to a first vertical position for loading/unloading of hay bales H to and from the ground, to a second horizontal position for loading hay bales H onto the static bed 20, and for transport. A first hydraulic ram 36 and a second hydraulic ram 37 are disposed generally centrally between the first generally rectangular portion 31 and the second generally rectangular portion 32. The first hydraulic ram 36 and the second hydraulic ram 37 are connected to the hay engagement portion 40 in order to slidably move the dolly 41 of the hay engagement portion 40 from the first position to the second position and back. A support chain 43 is connected at one end of the hay engagement portion 40, and at the other end to the tilt bed 30 in order to support the hay engagement portion 40 as hay bales H are drawn in.

The tilt bed 30 also includes a first hydraulic lift 38 and a second hydraulic lift 39 to tilt the tilt bed 30 about the pivot point 35 from the horizontal position to the vertical position and back.

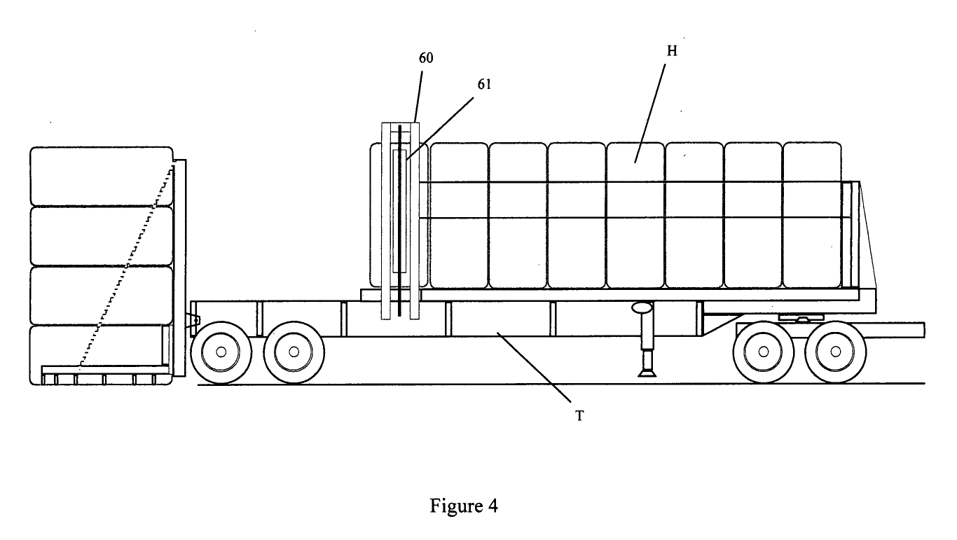

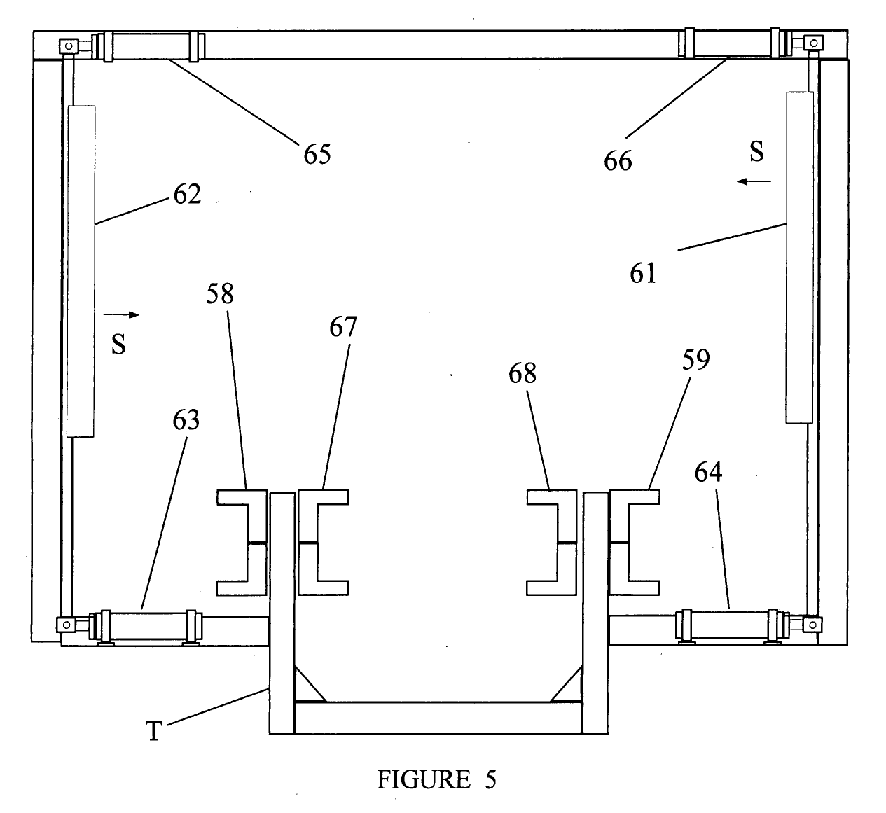

Referring now to FIG. 4, a nearly loaded hay bale retriever/stacker is shown. This depiction can either be representative of the loading operation or the unloading operation of hay bales H. Referring now to FIG. 5, the hay bale stabilizer 60 will now be described in detail. The hay bale stabilizer 60 includes a first squeeze bar 61 and a second squeeze bar 62 disposed on opposite sides of the hay bale stabilizer 60. A first hydraulic ram 63 is disposed at the bottom of the second squeeze bar 62 and a second hydraulic ram 65 is disposed at the top of the second squeeze bar 62. A third hydraulic ram 64 is disposed at the bottom of the first squeeze bar 61 and a fourth hydraulic ram 66 is disposed at the top of the first squeeze bar 61. In operation, the first hydraulic ram 63 and the second hydraulic ram 65 cause the second squeeze bar 62 to move translationally in the direction of the arrow ‘S’, and the third hydraulic ram 64 and the fourth hydraulic ram 66 cause the first squeeze bar 61 to move translationally in the direction of the arrow ‘S”, in order stabilize a hay bale H during loading and unloading. A first static track 58 and a second static track 59 run the entire length of the static bed 20 so that the headache rack 50 can be moved from the first position to the second position and back. A first dolly static track 67 and a second dolly static track 68 are mounted on the static bed 20 to receive the dolly 41 from the tilt bed 30 to move the hay bales H onto the static bed.

Referring again now to FIGS. 1, 2A and 2B, a loading operation will be described. In the first position, the tilt bed 30 is positioned vertically to engage hay bales H, via the hay engagement portion 40. Once hay bales H are engaged by the engagement portion 40, the tilt bed 30 pivots about the pivot 35 to the second horizontal position. The first hydraulic ram 36 and the second hydraulic ram 37 slide the dolly 41 along the tilt bed 30 in the direction of arrow ‘L’ from the first position to the second position and onto the dolly static tracks 67 and 68 on the static bed 30. In this manner, the hay bales H are pushed toward engagement with the headache rack 50. As more hay bales H are loaded onto the hay bale retriever/stacker 10, the headache rack 50 is pushed forward by the additional hay bales H toward the front end 21 of the static bed 20. The first hydraulic ram 36 and the second hydraulic ram 37 then slide the dolly 41 in the direction of the arrow ‘U’ back to the first position. The loading process can then be repeated. In each loading operation, the hay bales H are held in place by the squeeze bars 61 and 62, while the dolly 41 returns to allow the tilt bed 30 to tilt back to the vertical position to pick up another set of hay bales H.

Referring now to FIGS. 2A, 2B, 3A, 3B and 4, an unloading operation of the hay bale retriever/stacker 10. The hydraulic ram 51 drives the chain 52 in the direction of the arrow ‘U’. The chain 52, being connected to the headache rack 50, pulls the headache rack 50 in the direction of the arrow ‘U’ along the rollers 53. As the headache rack 50 slides in the direction of the arrow ‘U’, any hay bales H are directed toward the back end 22 of the static bed 20, and onto the dolly 41 of the hay engagement portion 40 on the tilt bed 30. To unload the hay bales H from the tilt bed 30, the tilt bed 30 pivots about the pivot 35 from the second horizontal position to the first vertical position. The hay bales H can then be offloaded from the tilt bed 30.

Referring again to FIGS. 2A and 2B, an alternative method of unloading the hay bales H will be described. To unload the hay bales H, the winch 54 is turned. As the winch 54 is turned, the cable 57 pulls the headache rack 50 from the second position to the first position along the arrow ‘U’. As the headache rack 50 slides from the second position to the first position, the hay bales H are also moved in the direction of the arrow ‘U’ onto the tilt bed 30 for unloading.

In view of the foregoing disclosure, some advantages of the present invention can be seen. For example, a novel hay bale retriever/stacker is disclosed. The hay bale retriever/stacker allows for hay bales to be easily loaded and unloaded onto a flat bed and transported from location to location. The hay bale retriever/stacker is on a trailer so as to facilitate using a standard tractor trailer arrangement to transport the hay bales.

While the preferred embodiment of the present invention has been described and illustrated, modifications may be made by one of ordinary skill in the art without departing from the scope and spirit of the invention as defined in the appended claims. For example, in the present invention, the hay bale stabilizer is described as utilizing squeeze bars to stabilize the hay bales, however, any means to stabilize the hay bales known to one of ordinary skill in the art may be employed. For example, a tines stanchion could be used to stabilize the hay bales. Also, a hydraulic ram or a winch and chain mechanism have been described for sliding the headache rack from position to position, however any means to slide the headache rack from position to position known to one of ordinary skill in the art may be employed.

1. A hay bale retriever/stacker, comprising:
a static bed, having a front end and a rear end;
a tilt bed, mounted at the rear end of the static bed;
a hay engagement portion, mounted on the tilt bed, for engaging hay bale during retrieval;
a headache rack, slidably mounted on the static bed, capable of sliding from a first position proximate to the rear end of the static bed to a second position proximate to the front end of the static bed; and
a hay bale stabilizer disposed on the static bed proximate to the rear end of the static bed to stabilize the hay bale.

2. The hay bale retriever/stacker of claim 1, further comprising:
at least one hydraulic ram mounted on the tilt bed to move the hay bale forward to the static bed.

3. The hay bale retriever/stacker of claim 2, further comprising a second hydraulic ram mounted on the tilt bed to move the hay bale forward to the static bed.

4. The hay bale retriever/stacker of claim 2, further comprising a hydraulic winch and cable mounted on the static bed for slidably moving the headache rack from the second position to the first position.

5. The hay bale retriever/stacker of claim 4, further comprising a corner post disposed at the front end of the static bed.

6. The hay bale retriever/stacker of claim 5, further comprising static cables disposed between and mounted on the corner post and the hay bale stabilizer, on opposing sides of the static bed.

7. The hay bale retriever of claim 2, further comprising a hydraulic ram mounted on the static bed, connected to the headache rack for sliding the headache rack from the second position to the first position.

8. The hay bale retriever of claim 7, further comprising a chain, the chain having one end mounted at an end of the hydraulic ram mounted on the static bed and the other end of the chain connected to the headache rack to slide the headache rack from the second position to the first position.

9. The hay bale retrieve/stacker of claim 1, further comprising a dolly mounted on the hay engagement portion, wherein the dolly is capable of sliding from the first position to the second position to load and unload hay bales.

10. The hay bale retriever/stacker of claim 1, wherein the hay bale stabilizer includes a first squeeze bar for stabilizing the hay bales.

11. The hay bale retriever/stacker of claim 10, wherein the hay bale stabilizer includes a second squeeze bar for stabilizing the hay bales.

12. The hay bale stabilizer of claim 11, further comprising at least one hydraulic ram for activating the first squeeze bar and at least one hydraulic ram for activating the second squeeze bar.

13. The hay bale stabilizer of claim 1, wherein the hay bale stabilizer is a tines stanchion.

14. A hay bale retriever/stacker, comprising:
a static bed, having a front end and a rear end;
a tilt bed, pivotally mounted at the rear end of the static bed;
a hay engagement portion, mounted on the tilt bed, for engaging a hay bale during retrieval;
a headache rack, slidably mounted on the static bed, capable of sliding from a first position proximate to the rear end of the static bed to a second position proximate to the front end of the static bed;
a hay bale stabilizer disposed on the static bed proximate to the rear end of the static bed to stabilize the hay bale;
a first hydraulic ram mounted on the tilt bed to move the hay bale forward to the static bed;
a second hydraulic ram mounted on the tilt bed, proximate to the first hydraulic ram, to move the hay bale forward to the static bed; and
a hydraulic winch and cable mounted on the static bed for slidably moving the headache rack from the second position to the first position.

15. The hay bale retrieve/stacker of claim 14, further comprising a dolly mounted on the hay engagement portion, wherein the dolly is capable of sliding from the first position to the second position to load and unload hay bales.

16. The hay bale retriever/stacker of claim 14, wherein the hay bale stabilizer includes a first squeeze bar for stabilizing the hay bales.

17. The hay bale retriever/stacker of claim 16, wherein the hay bale stabilizer includes a second squeeze bar for stabilizing the hay bales.

18. The hay bale stabilizer of claim 17, further comprising at least one hydraulic ram for activating the first squeeze bar and at least one hydraulic ram for activating the second squeeze bar.

19. The hay bale stabilizer of claim 14, wherein the hay bale stabilizer is a tines stanchion.

20. A hay bale retriever/stacker, comprising:
a static bed, having a front end and a rear end;
a tilt bed, pivotally mounted at the rear end of the static bed;
a hay engagement portion, mounted on the tilt bed, for engaging a hay bale during retrieval;
a headache rack, slidably mounted on the static bed, capable of sliding from a first position proximate to the rear end of the static bed to a second position proximate to the front end of the static bed;
a hay bale stabilizer disposed on the static bed proximate to the rear end of the static bed to stabilize the hay bale;
a first hydraulic ram mounted on the tilt bed to move the hay bale forward to the static bed;
a second hydraulic ram mounted on the tilt bed, proximate to the first hydraulic ram, to move the hay bale forward to the static bed;
a hydraulic ram mounted on the static bed, connected to the headache rack for sliding the headache rack from the second position to the first position; and
a chain, the chain having one end mounted at an end of the hydraulic ram mounted on the static bed and the other end of the chain connected to the headache rack to slide the headache rack from the second position to the first position.

21. The hay bale retrieve/stacker of claim 20, further comprising a dolly mounted on the hay engagement portion, wherein the dolly is capable of sliding from the first position to the second position to load and unload hay bales.

22. The hay bale retriever/stacker of claim 20, wherein the hay bale stabilizer includes a first squeeze bar for stabilizing the hay bales.

23. The hay bale retriever/stacker of claim 22, wherein the hay bale stabilizer includes a second squeeze bar for stabilizing the hay bales.

24. The hay bale stabilizer of claim 23, further comprising at least one hydraulic ram for activating the first squeeze bar and at least one hydraulic ram for activating the second squeeze bar.

25. The hay bale stabilizer of claim 20, wherein the hay bale stabilizer is a tines stanchion.
